(19) United States
(12) Patent Application Publication
(10) Pub. No.: US 2021/0072123 A1
(43) Pub. Date: Mar. 11, 2021

(54) Device for Processing and Infiltrating Histological and Biological Samples

(71) Applicant: Eleonora Iljinichna Tjan, St. Petersburg (RU)

(72) Inventor: Eleonora Iljinichna Tjan, St. Petersburg (RU)

(21) Appl. No.: 17/053,377

(22) PCT Filed: May 7, 2018
(86) PCT No.: PCT/RU2018/000294

§ 371 Date: Nov. 6, 2020

(51) Int. Cl. G01N 1/28; B01F 9/10; B05C 3/02

(52) U.S. Cl. CPC G01N 1/2813; B01F 9/103; G01N 1/286; B05C 3/02; B01F 9/106

(57) ABSTRACT

A device comprising a rotating means enclosed in a housing and having a horizontally arranged rotating shaft. Containers for cassettes containing samples are mounted on the rotating shaft and are joined in the form of a vertically arranged ring. The device has a means for rotating the rotating shaft at a variable speed and vessels containing processing and infiltrating liquids, said vessels being arranged outside the housing and being connected thereto by pipes for feeding in and discharging said liquids. The device additionally contains a mechanism for orienting the containers for cassettes containing samples, which mechanism is arranged between the ring of containers and the wall of the device, has a separate means for transferring the containers for cassettes containing samples into a horizontal or inclined position and holds same in the horizontal or inclined position.

### CROSS REFERENCE TO RELATED APPLICATIONS

This application is the U.S. national stage of International Application No. PCT/RU2018/000294, filed on 2018 May 7.

### BACKGROUND

### Field of Use of the Invention

The present invention relates to examination methods and in particular to devices for preparation of histological and biological specimens for microscopic examination.

Prior to sectioning, tissue samples taken for examination must be fixed by an aqueous or hydroalcoholic formaldehyde solution, then dehydrated with a liquid miscible with water, then cleared with an organic liquid that mixes well with both dehydrating liquid and paraffin (or other wax), thereafter they must be infiltrated with a melted paraffin or other wax.

For sectioning, a paraffin impregnated sample must be secured in a microtome holder. In order to secure the sample in a standard microtome holder, it must be embedded in a paraffin block. Paraffin is cut together with the sample, and obtained sections are then stretched in water and placed on a glass slide. Preparation of paraffin block is a separate procedure. The histological sample that has undergone dehydration and wax infiltration is placed into a mold of an appropriate size, orienting so that the part of the sample intended for examination is pressed to the bottom of the mold, the mold is filled with paraffin and covered by a marked cassette in which the sample contained during dehydration and waxing, with cassette lid removed. The cassette becomes a support for the block when securing it in the microtome.

The operation of blocks preparation is called embedding, and special embedding devices are used for its implementation, comprising a container with melted paraffin, heated containers for molds and sample cassettes, and a cooled surface to complete the formation of blocks.

The disadvantages of the standard embedding procedure are its laboriousness, non-ergonomics and chemical hazard to personnel (residues of clearing liquid—xylene), as well as the error possibility in the numbering of cassettes when transferring samples.

### PRIOR ART

Attempts to automate the embedding process have been made repeatedly. To automate this process, two conditions must be met: the sample must be located at the bottom of the mold in order to appear on the top of the block, and it must be oriented in a certain way to obtain sections.

Milestone Pathos Delta and Logos histological specimen processing and embedding devices from Milestone SRL [Milestone+Klinipath “Rapid Tissue Processing and Auto-embedding ALL-IN-ONE Synergy” brochure] includes a ring-shaped rack for sample cassettes placed in the processor chamber. During samples processing the cassettes are located on the rack shelves at an angle; when switching to the embedding process, the cassettes are oriented horizontally.

After embedding, the cassettes are removed from the processor and placed for cooling on the cooling panel (see broshure). When these devices are used, specifically designed cassette-mold assemblies from Klinipath B.V. [EP 2439510, IPC G01N1/36, 2016] are used, with a recess at the bottom of which a histological specimen is placed, covered with a sponge permeable to process liquids and melted paraffin; the mold has expanding flanges and a central opening; the opening is covered by a standard cassette for histological samples, abutting against the edges of the mold. As shown in the brochure, after cooling, the block with the sample and cassette is easily separated from the mold and fed to sectioning.

During tissue processing, the liquid inside the ring rack can be mixed with a magnetic stirrer; however, this is not enough for efficient fluid exchange in a sample firmly pressed to the bottom of the mold; therefore, it is proposed to use microwave radiation to accelerate the process. While for 1 mm thick samples time of tissue processing and embedding is 1 hour 35 minutes, then 5 mm thick samples require 5 hours 35 minutes (brochure, p. 5). Thus, the device should be loaded with cassettes with samples of the same thickness, since when loading samples of different thickness, some of them may be overexposed during tissue processing, and some may not pass through the tissue processing completely, which limits the use of this tissue processor. Besides, the device and the method of its operation does not imply the simultaneous loading of various cassettes—both conventional and cassette-mold assemblies; this sharply decrease the capacity—40 cassette-mold assemblies, while with standard cassettes the capacity is 300 pieces.

Processors in which both tissue processing- and embedding of histological and biological samples can be performed in cassette-mold assemblies have been repeatedly proposed (see, for example, U.S. Pat. No. 8,900,857, IPC C12M3/00, 2014; U.S. Pat. No. 9,733,166, IPC G01N1/36, 2017; U.S. Pat. No. 9,194,776, IPC A61B10/00, 2015; U.S. Pat. No. 9,568,402, IPC A61B10/00, 2017), however, they have no means for acceleration of tissue processing, which does not allow timely completion of processing of samples tightly pressed to the bottom of the mold.

A device for processing and impregnating of histological and biological samples (RU2150097, IPC G01N1/28, 2000) allows to increase processing productivity while maintaining its high efficiency. The device includes a rotating mean enclosed in a housing, the axis of rotation of which is arranged horizontally, with cassette containers with samples mounted in the form of a vertically arranged ring mounted on the axis, means for rotating the axis of rotation with variable speed and vessels with processing and impregnating liquids located outside the housing and pipes connected to it for supplying and discharging said liquids. Sample cassettes are placed in containers. The level of processing and impregnating liquids is set approximately at the level of the rotation axis. When the axis rotates, the containers alternately submerge into the processing fluid and exit it; while the processing fluid flows out from the containers and cassettes with the samples and refills them. The specified device allows to process and impregnate histological samples in cassette-mold assemblies with high efficiency and productivity, however, it is not suitable for embedding since the sample cassettes do not keep horizontal orientation in containers, necessary for holding melted paraffin in cassette-mold assemblies during embedding.

### SUMMARY

A device comprises a rotating means enclosed in a housing and having a horizontally arranged rotating shaft. Containers for cassettes containing samples are mounted on the rotating shaft and are joined in the form of a vertically arranged ring. The device has a means for rotating the rotating shaft at a variable speed and vessels containing processing and infiltrating liquids, said vessels being arranged outside the housing and being connected thereto by pipes for feeding in and discharging said liquids.

The device additionally contains a mechanism for orienting the containers for cassettes containing samples, which mechanism is arranged between the ring of containers and the wall of the device, has a separate means for transferring the containers for cassettes containing samples into a horizontal or inclined position and holds same in the horizontal or inclined position.

The mechanism for orienting the containers can be in the form of a geared transmission with intermediate pinions which are in engagement with a central pinion and with external pinions or can be in the form of a planetary transmission or a parallelogram mechanism

### DETAILED DESCRIPTION

The basis of the invention is the task of creating a device in which effective processing and infiltration of histological and biological samples and the subsequent embedding of blocks for microtomy could be carried out.

Said objective is solved in a way that in the device for processing and impregnation of histological and biological samples, including rotating means enclosed in the housing, the axis of rotation of which is placed horizontally, with containers for sample cassettes mounted on it, combined in the form of a vertically arranged ring, means for rotation of the rotation axis with variable speed and vessels with processing and impregnating liquids, located outside the housing and connected to it by pipes for feeding and draining said liquids, further provided with mechanism for orientation of containers with sample cassettes, located between the ring of containers and the wall of the device, having separate means for turning sample cassettes containers into horizontal or inclined position and holding them in a horizontal or inclined position.

The mechanism for orienting containers and holding them in a horizontal or inclined position can be made in the form of mechanisms known from the prior art, but never before used in apparatus for processing, infiltration or embedding biological and histological samples, for example, in the form of a gear transmission, or in the form of a planetary gear, or in the form of a parallelogram mechanism.

Containers for cassettes in the inventive device are made square in cross section. In the inventive device, samples placed both in standard cassettes and in cassette-mold assemblies can be processed simultaneously, since containers for standard cassettes and cassette-mold assemblies are interchangeable.

### BRIEF DESCRIPTION OF THE DRAWINGS

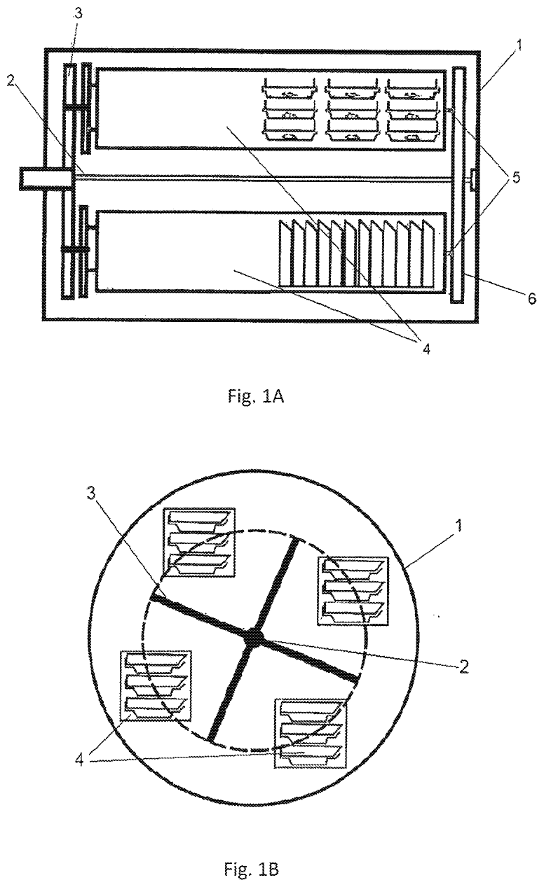

The inventive processor is shown in FIGS. 1-4.

In FIGS. 1A and 1B schematically shown the arrangement of a ring of containers with cassettes housed therein, mounted on an axis of rotation.

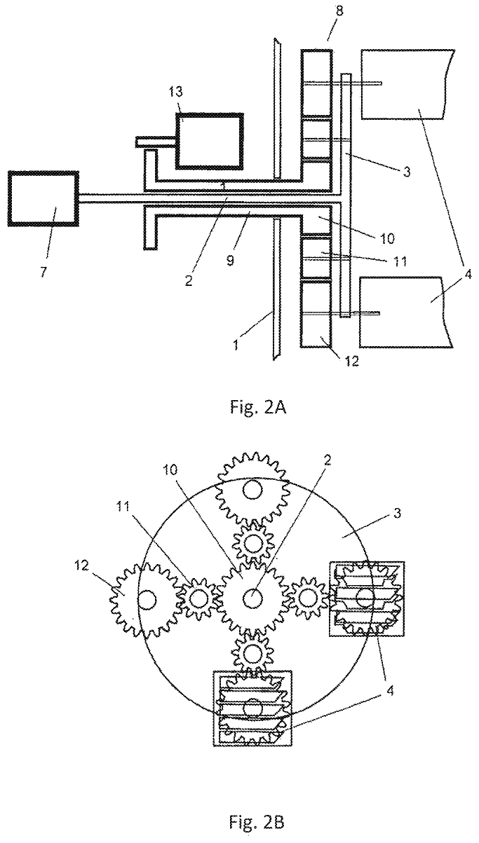

In FIGS. 2A and 2B shown a gear transmission located between the container ring and the processor wall.

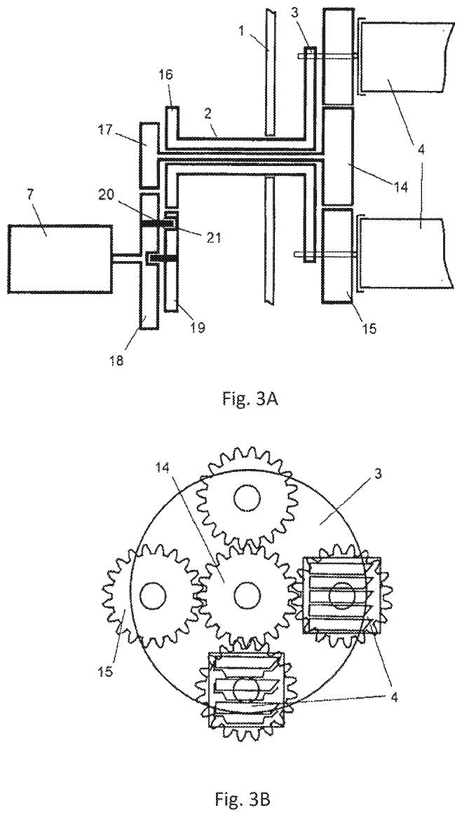

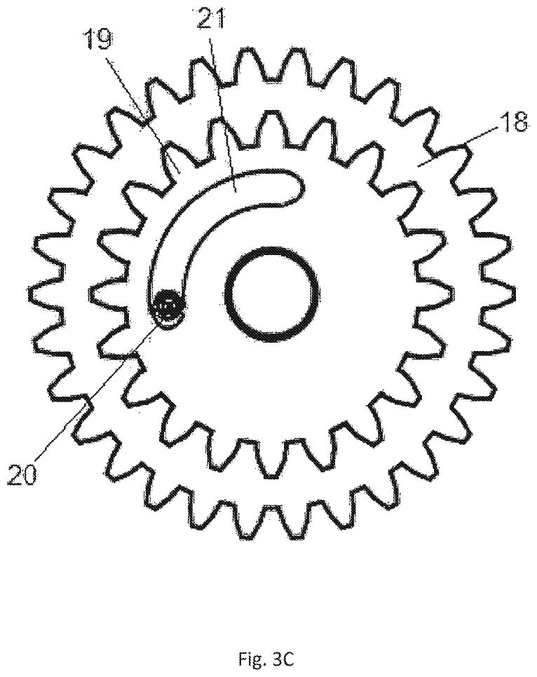

In FIG. 3A-3C shown a planetary gear located between the container ring and the processor wall.

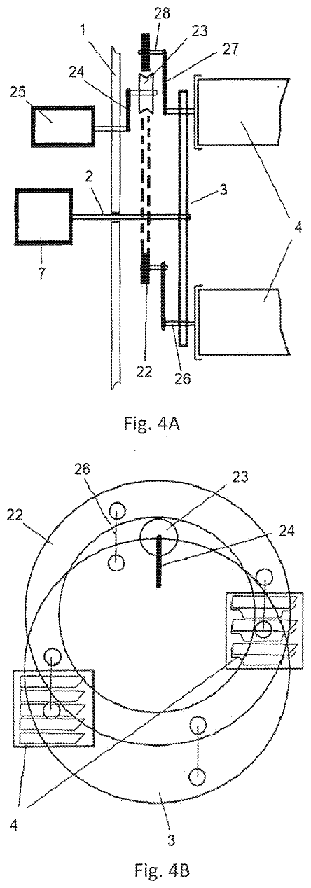

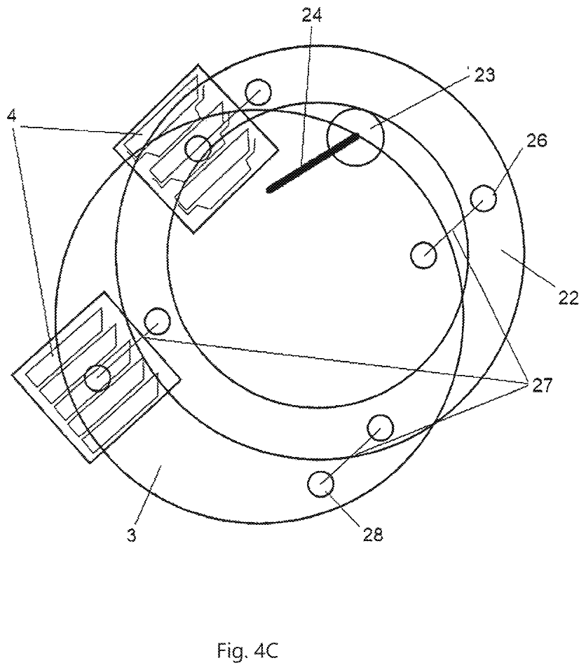

In FIG. 4A-4C shown a parallelogram mechanism for transferring containers into a horizontal or inclined position.

### DETAILED DESCRIPTION OF THE PREFERRED EMBODIMENTS

Presented schematically in FIGS. 1A and 1B, the processor has a housing 1 in which the axis of rotation 2 is located horizontally. A turntable 3 is mounted on the axis 2, on which containers 4 with cassettes or cassette-mold assemblies with histological samples are fixed. The containers are fixed with axes 5 on the supporting disk 6 (FIG. 1B). Axis 2 rotates by drive 7.

In the case of using a gear transmission (FIGS. 2A-2B), a container orientation mechanism 8 holding them in a horizontal or inclined position is placed between the wall of the housing 1 and the turntable 3 (FIG. 2A). The mechanism 8 includes the central gear 10, fixed on the hollow axis 9, entering the processor (FIG. 2B). Inside the hollow axis 9, there passes a rotation axis 2, on which the turntable 3 is fixed. The intermediate gears 11 and the external gears 12 are mounted on the turntable 3, the intermediate gears 11 being engaged simultaneously with the central gear 10 and the external gears 12. The containers 4 are fastened to the external gears 12. A separate drive 13 is used to transfer containers into a horizontal or inclined position.

A planetary gear is placed between the containers 4 and the turntable 3 and includes a central gear 14 and the external gears 15 to which containers 4 are fixed (FIGS. 3A and 3B). The turntable 3 is connected by a hollow axis 2 to the gear 16. Inside the hollow axis 2 passes an axis, connecting the central gear 14 of the planetary gear with the external gear 17, engaged with the gear 18, located on the axis of the drive 7. The gear 19 engaged with the gear 16, is made coaxial with the gear 18. To limit the angle of mutual rotation an eccentric pin 20 is made on the gear 18, and on the gear 19 is made a circular groove 21 (see FIG. 3C), into which the pin 20 enters.

A parallelogram mechanism is placed between the turntable 3 and the wall of the housing 1 (FIGS. 4A-4C). The mechanism includes a ring 22 located above the turntable 3 and supported by a support roller 23, mounted on a pivot arm 24 with an axis and an additional drive 25, located outside the processor. The axes of the container holders 26 are connected by levers 27 with the corresponding axes 28 located on the ring 22.

The mechanisms for transferring containers for sample cassettes to a horizontal or inclined position work as follows.

Transferring (switching) of the gear mechanism: when the turntable 3 is stopped, with the help of a separate drive 13, the central gear 10 is rotated by a certain angle; while the external gears 12 and the associated containers 4 are also rotated by the same angle. After that, the drive 13 is stopped, the drive 7 is turned on, and the external gears 12 and the associated containers 4 rotate together with the turntable 3 in a new, unchanged position related to horizontal.

Transferring (switching) of the planetary mechanism: by means of drive 7 the gear 18 rotates counterclockwise; meanwhile the pin 20 moves in the groove 21. The second gear 19 is stationary until the pin 20 reaches the end of the groove 21—during this period the turntable 3 is also stationary, the central gear 14 rotates and turns the external gears 15 with the holders of the containers 4, this changes the position of the containers relative to the horizontal. After the pin 20 reaches the end of the groove 21, the gears 18 and 19, the turntable 3 and the central gear 14 begin to rotate together and until the next switching of the planetary mechanism, the position of the external gears 15 with the holders of the containers 4 remains unchanged.

Transferring (switching) of the parallelogram mechanism: with the vertical position of the lever 24 (FIG. 4B) of the support roller 23, the connecting levers 27 of the axes 28 of the containers are also directed vertically, and the containers 4 are located horizontally. To change the position of the containers, the lever 24 of the support roller is rotated, the ring 22 is shifted in the same direction, the connecting levers 27 synchronously turns the axis 26 of the holders of the containers 4, which take an inclined position (FIG. 4C), which is maintained during rotation of the turntable 3.

The inventive device operates as follows.

At the beginning of the cycle, when loading containers with cassettes and cassette-mold assemblies, for the convenience of loading, the containers are arranged horizontally. The containers loaded with cassettes and cassette-mold assemblies are transferred by means of the used orientation mechanism to an inclined (5-90° to horizontal) position.

A small vacuum is created in the housing 1, under the influence of which the first liquid is sucked into the housing from a vessel placed outside the housing (not shown). The level of the processing liquids is set below axis 2 or at its level. Drive 7 begins to rotate containers 4 at a speed of 1-10 rpm. When the axis rotates, the containers alternately submerges and exits the processing liquid; wherein the processing liquid drips down from the containers and cassettes or cassette-mold assemblies and fills them again. At the end of each processing step, liquid from the housing is removed into an appropriate vessel and the drive rotational speed is increased, which allows droplet moisture to be removed from containers and cassettes (and cassette-mold assemblies) with samples. Processing can be carried out under a vacuum of 200-600 mm Hg.

Upon completion of processing and paraffin impregnation of the samples, the containers are transferred to the horizontal position by means of the used orientation mechanism, which makes it possible to embed the samples with paraffin to obtain blocks used in sectioning. Upon completion of embedding, the paraffin from the chamber is drained and the heating of the chamber is turned off so that the paraffin in the cassette-mold assemblies solidifies.

The inventive device allows not only to process and impregnate histological samples with high efficiency and productivity, using both standard cassettes and cassette-mold assemblies in one load, but also to embed blocks in the same apparatus in cassette-mold assemblies, which eliminates labourious and time-consuming manual embedding procedure, as well as possible identification errors of samples.

### INDUSTRIAL APPLICABILITY

The inventive device for processing and impregnation of histological and biological samples can be used in laboratories specializing in histological (pathological) and cytological studies, as well as in any other biological and medical institutions involved in microscopic studies of tissues and cells.

1. A device for processing and infiltration of histological and biological samples, including rotating means enclosed in a housing, the axis of rotation of which is placed horizontally, with sample cassette containers mounted on it, combined in the form of a vertically arranged ring, means for rotating the axis of rotation with variable speed and vessels with processing and impregnating liquids located outside the housing and connected to it by pipes for supplying and unloading said liquids, characterized in that there additionally made a mechanism for orientation of containers for sample cassettes, located between the container ring and the device wall, which has a separate means for transferring sample cassettes containers for into horizontal or inclined position, holding them in a horizontal or inclined position.

2. The device according to claim 1, characterized in that the container orientation mechanism is made in the form of a gear transmission with intermediate gears engaged with the central and external gears.

3. The device according to claim 1, characterized in that the container orientation mechanism is made in the form of a planetary gear.

4. The device according to claim 1, characterized in that the container orientation mechanism is made in the form of a parallelogram mechanism.

5. The device according to claim 1, characterized in that the containers for cassettes have a square cross section.
